(19) United States
(12) Patent Application Publication
(10) Pub. No.: US 2006/0072011 A1
(43) Pub. Date: Apr. 6, 2006

(54) Vehicle peripheral visual confirmation apparatus

(75) Inventor: Jun Okada, Mie (JP)

Correspondence Address: OLIFF & BERRIDGE, PLC, P.O. BOX 19928, ALEXANDRIA, VA, 22320, US

(73) Assignees: AUTONETWORKS TECHNOLOGIES, LTD., Yokkaichi-shi (JP); SUMITOMO WIRING SYSTEMS, LTD., Yokkaichi-shi (JP); SUMITOMO ELECTRIC INDUSTRIES, LTD., Osaka-shi (JP)

(21) Appl. No.: 11/193,358

(22) Filed: Aug. 1, 2005

(30) Foreign Application Priority Data
Aug. 4, 2004 (JP) P2004-228298

(51) Int. Cl. H04N 7/18; B60Q 1/00; G08G 1/14

(52) U.S. Cl. 348/148; 340/435; 340/932.2

(57) ABSTRACT

A camera taking an image in a wide range of a visual field cuts out, an image of a vehicle's rear part of the image picked up by the camera. The camera rotates or inverts the image and adjusts the image in the direction corresponding to a mirror image of a door mirror. The rearward image that can be sensitively, easily and visually recognized by a driver can be provided. A forward image or the sideward image is properly switched as required. When a part of the image picked up by the camera is cut out, images showing the range of the visual field of the cut out image are synthesized and displayed in a display device.

### BACKGROUND OF THE INVENTION

1. Field of the Invention

The present invention relates to a vehicle peripheral visual confirmation apparatus by which a driver visually recognizes a vehicle peripheral that cannot visually recognized from a driver's seat of vehicle.

2. Description of the Related Art

When the driver visually recognizes the position that is not open to the eye of the driver in the driver's seat of the vehicle, the images of prescribed directions in the periphery of the vehicle have been hitherto picked up by a camera provided in the vehicle and the picked-up images have been displayed on a display device disposed in the vehicle.

For instance, in the case of a vehicle 1 having a right handle, a camera 3 has been ordinarily disposed only in a left side as shown in FIG. 20, the image of a scene located in a prescribed range 4 of the left side of the vehicle 1 including the front wheel of the vehicle has been usually picked up by the camera 3. Then, the driver visually recognizes the picked up image displayed on the display device to recognize a positional relation between an obstacle and the user's vehicle. The camera 3 is embedded and installed in, for instance, a side mirror (a door mirror) 5.

### SUMMARY OF THE INVENTION

As described above, when the images of right and left scenes are picked up by the camera 3, the images of the scenes of a wide range are desirably picked up by the camera 3 as much as possible. Accordingly, a proposal has been made that a fisheye lens is provided in the camera 3 to increase the range of a visual field.

However, when the range of the visual field of the camera 3 is widened by the fisheye lens or the like, even if the picked up image is directly displayed on the display device, in most of cases, the direction of the picked up image is hardly sensitively grasped. Consequently, the driver undesirably hardly visually recognizes the picked up image.

It is an object of the present invention to provide a vehicle peripheral visual confirmation apparatus that can provide an image easily seen by a driver.

According to one aspect of the invention, there is provided a vehicle peripheral visual confirmation apparatus including: a camera being disposed in a side part of vehicle, and the camera being simultaneously capable of picking up at least one of an image in a front part of the side part of vehicle and an image in a rear part of the side part of vehicle, a display device displaying an image; and a display controller processing the image picked up by the camera to output the processed image to the display device, the display controller operable to cut out a part of the image picked up by the camera, the display controller operable to rotate the image, and the display controller operable to invert the image.

According to another aspect of the invention, the display controller cuts out the image in the rear part of the vehicle among the images picked up by the camera. The display controller performs at least one of a rotation of the cut-out image in a direction corresponding to the mirror image of door mirror and a inversion of the cut-out image in a direction corresponding to the mirror image of door mirror.

According to the above-aspect of the invention, when the camera can pick up an image in the front part of the side part of the vehicle and an image in the rear part of the side part of the vehicle at the same time, a part of the image picked up by the camera can be cut out, and the image can be rotated and inverted. Thus, the image in the rear part of the vehicle of the images picked up by the camera can be cut out and the image can be adjusted in the direction corresponding to the mirror image of a door mirror. Accordingly, the rearward image that can be sensitively visually recognized by a driver can be provided and a display can be switched so that a forward image or a sideward image can be suitably visually recognized as required.

According to another aspect of the invention, the camera has a fisheye lens so that the two images can be picked up at the same time.

Since the camera has a fisheye lens, both the images of the front part of the side part and the rear part of the side part of the vehicle can be easily picked up at the same time.

According to another aspect of the invention, the camera is disposed in the door mirror.

Since the camera is disposed in the door mirror, the appearance of the vehicle is not deteriorated.

According to another aspect of the invention, when the display controller cuts out a part of the image picked up by the camera, the display controller synthesizes an image representing a range of a visual field of the cut-out image and controls the display device to display the synthesized image.

According to the above-aspects of the invention, when the display controller cuts out a part of the image picked up by the camera, the display controller synthesizes an image showing the range of a visual field of the cut-out image and controls the display device to display the obtained image. Thus, the range of the visual field of the displayed image can be easily recognized.

### BRIEF DESCRIPTION OF THE DRAWINGS

FIG. 1 is a diagram showing a range of a visual field in which an image is picked up by a camera of a vehicle peripheral visual confirmation apparatus for a periphery of a vehicle according to one embodiment.

FIG. 2 is a diagram showing the range of the visual field in which an image is picked up by the camera of the apparatus according to the one embodiment.

FIG. 3 is a schematic view showing the camera of the apparatus according to the one embodiment.

FIG. 4 is a diagram showing an image picked up by the camera of the apparatus according to the one embodiment.

FIG. 5 is a diagram showing a state that the image picked up by the camera of the apparatus according to the one embodiment is rotated by 90°.

FIG. 6 is a diagram showing a state that an obstacle located rearward the vehicle is reflected as a vertically inverted image.

FIG. 7 is a diagram showing the obstacle reflected on a door mirror.

FIG. 8 is a diagram showing a range of a visual field in which the image of the obstacle located rearward the vehicle is picked up.

FIG. 9 is a diagram showing a state that a cut out and inverted image is displayed in the apparatus according to the one embodiment.

FIG. 10 is a block diagram showing a specific structural example of the apparatus according to the one embodiment.

FIG. 11 is a diagram showing a state that the front part of the vehicle is displayed in the apparatus according to the one embodiment.

FIG. 12 is a diagram showing a state that an image is cut out and displayed in the apparatus according to the one embodiment.

FIG. 13 is a diagram showing one state of the vehicle.

FIG. 14 is a diagram showing the image of a rear part of the vehicle reflected on the door mirror under the state shown in FIG. 13.

FIG. 15 is a diagram showing an example that a cut out and inverted image is displayed by the apparatus according to the one embodiment under the state shown in FIG. 13.

FIG. 16 is a diagram showing the difference in the range of a visual field between the cut out and inverted image and a mirror image of the door mirror.

FIG. 17 is a diagram showing one state of the vehicle.

FIG. 18 is a diagram showing the image of the rear part of the vehicle reflected on the door mirror under the state shown in FIG. 17.

FIG. 19 is a diagram showing an example that a cut out and inverted image is displayed by the apparatus according to the one embodiment under the state shown in FIG. 17.

FIG. 20 is a schematic view showing a vehicle peripheral visual confirmation apparatus.

### DESCRIPTION OF THE PREFERRED EMBODIMENTS

Firstly, a principle of a visually recognizing device for a periphery of a vehicle according to one embodiment of the present invention will be described.

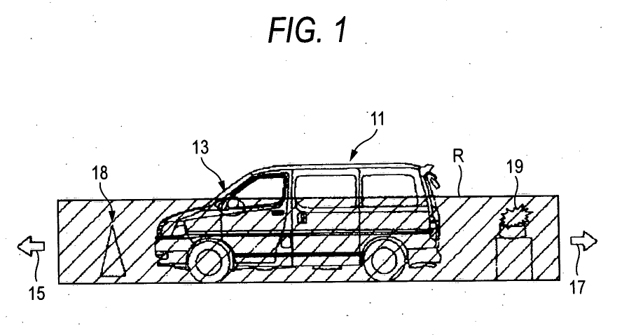

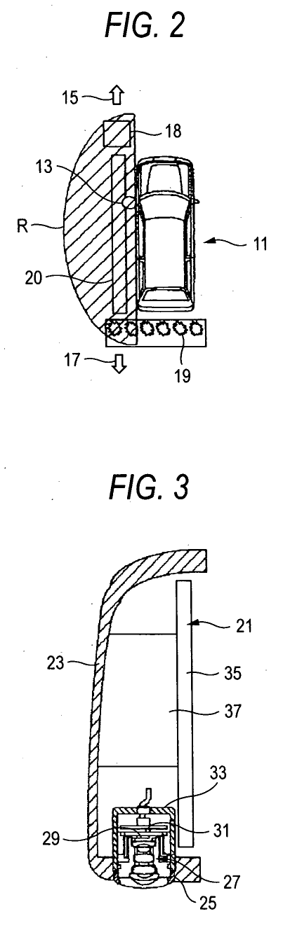

A vehicle peripheral visual confirmation apparatus picks up by a camera 13 installed on, for instance, a left side surface of a vehicle 11, the image of a scene having a prescribed wide range R of a visual field including both a front part 15 and a rear part 17 viewed from a position where the camera 13 is installed, as shown in FIGS. 1 and 2. Then, the apparatus displays obstacles 18 and 19 both in the front and rear parts of the vehicle included in the picked up image on a display device in the vehicle. Thus, a driver can easily visually recognize the obstacles 18 and 19 or a guide line (white line) 20 drawn on a road.

Here, as shown in FIG. 3, the camera 13 is fitted to an installing hole 25 formed in the lower end part of a casing member 23 of a door mirror 21 to pick up an image about a lower part of the door mirror 21. The camera 13 includes a lens system 27 using a fisheye lens to pick up the image of the wide range of a visual field including both the front part 15 and the rear part 17, an image pick up element 29 such as a CCD, a circuit board 31 for inputting and processing an image picked up by the image pick up element 29 and a water-proof case 33 for accommodating them. The image picked up by the image pick up element 29 is converted to a signal of a prescribed system such as an NTSC signal and the signal is transmitted to the display device (an illustration is omitted) in the main body of the vehicle through the circuit board. Reference numeral 35 in FIG. 3 designates a mirror body of the door mirror 21. Reference numeral 37 designates a mirror driving actuator for adjusting the angle of the mirror body 35, respectively.

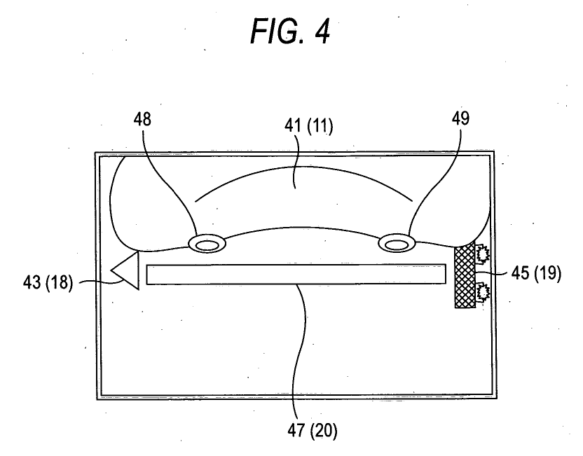

One example of the image picked up by the above-described camera 13 is shown in FIG. 4. The image shown in FIG. 4 corresponds to the state of the vehicle shown in FIGS. 1 and 2. Reference numeral 41 in FIG. 4 designates an image in a left side surface of the vehicle 11. Reference numeral 43 designates an image of the obstacle 18 located left forward the vehicle 11. Reference 45 designates an image of the obstacle 19 located rearward the vehicle 11. Reference numeral 47 designates an image of the guide line 20 drawn on the road. Reference numeral 48 designates an image of a front wheel of a left side of the vehicle 11. Reference numeral 49 designates an image of a rear wheel of a left side of the vehicle 11, respectively.

Since the image taken by the camera 13 needs to be picked up in a wide range of a visual field in forward and rearward directions, the image ordinarily has an aspect ratio of 3 to 4. The image is picked up so that a transverse direction as a longitudinal direction corresponds to the forward and rearward directions of the vehicle 11. Thus, the image of the entire part of the forward and rearward directions of the side surface part of the vehicle can be picked up.

However, since the picked up image shown in FIG. 4 is taken in a positional relation at right angles to the direction of a driver, that is, the actual forward and rearward directions of the vehicle 11, when such a picked up image is directly displayed on the display device, the driver hardly understand the relation between the picked up image and the direction of the vehicle 11.

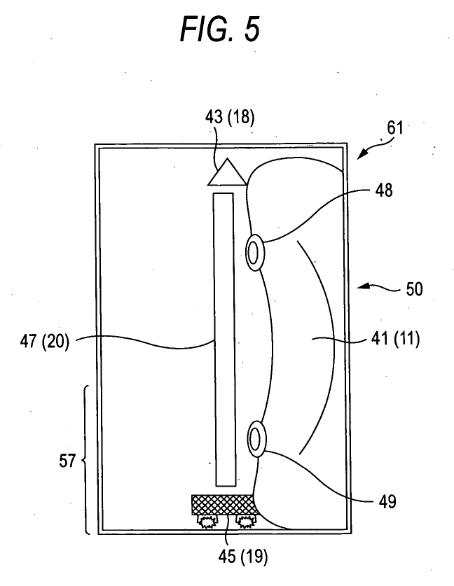

Therefore, an ordinary coordinate transformation process is carried out to the picked up image to rotate the picked up image by 90° as shown in FIG. 5 and display the image on the display device so that the upper side of the image corresponds the front part of the vehicle 11 and the lower side of the image corresponds to the rear part of the vehicle 11. Thus, the driver can conveniently easily understand the relation between the picked up image displayed on the display device and the direction of the vehicle 11.

The picked up image 50 shown in FIG. 5 is taken in the wide range of the visual field including the forward and rearward directions of the vehicle 11 from the visual point of the camera 13. Accordingly, as described above, not only a part near the side part of the vehicle 11, but also the image 43 of the obstacle 18 located left forward and the image 45 of the obstacle 19 located rearward the vehicle 11 are reflected.

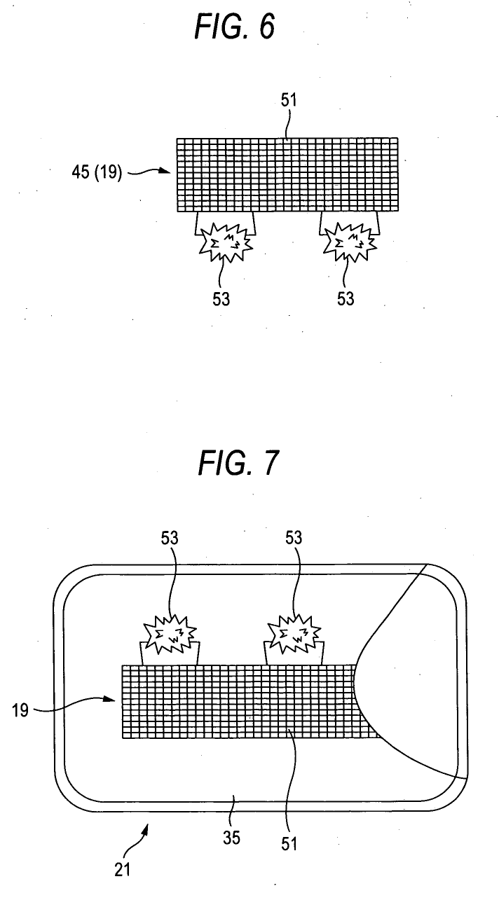

Here, when the image 45 of the obstacle 19 located rearward the vehicle 11 is noticed, in the picked up image 50 shown in FIG. 5, the image 45 of the obstacle 19 located rearward the vehicle 11 is reflected as shown in FIG. 6. The image 45 of the obstacle 19 shows an example in which vegetables 53 are planted on a planter 51. However, the image is picked up from the visual point of the camera 13 so that the forward and rearward direction of the vehicle 11 corresponds to the longitudinal direction in the range of the visual field, and the picked up image is rotated by 90° as described above. Accordingly, the picked up image shown in FIG. 6 appears to have an inverted positional relation in an upper part and a lower part to the actual obstacle 19, that is, the planter 51 and the vegetables 53.

As a comparative example, the image of the obstacle 19 visually recognized by the driver by using the mirror body 35 of the door mirror 21 is shown in FIG. 7. As shown in FIG. 7, the image of the obstacle 19 that the driver visually recognizes by using the mirror body 35 of the door mirror 21 can be visually recognized as the image having the vegetables 53 planted on the upper side of the planter 51. The upper and lower positional or vertical relation thereof corresponds to the actual upper and lower positional relation between the planter 51 and the vegetables 53. Then, an image that the driver is ordinarily used to see when the driver recognizes the rearward part of the vehicle 11 represents a correct upper and lower positional relation as shown in FIG. 7.

As compared therewith, the picked up image shown in FIG. 6 whose upper and lower or vertical positional relation appears as an inverted positional relation to the actual upper and lower positional relation of the obstacle 19. Thus, when the picked up image is displayed on the display device, the image 45 that is hardly sensitively understood is inconveniently displayed on the display device.

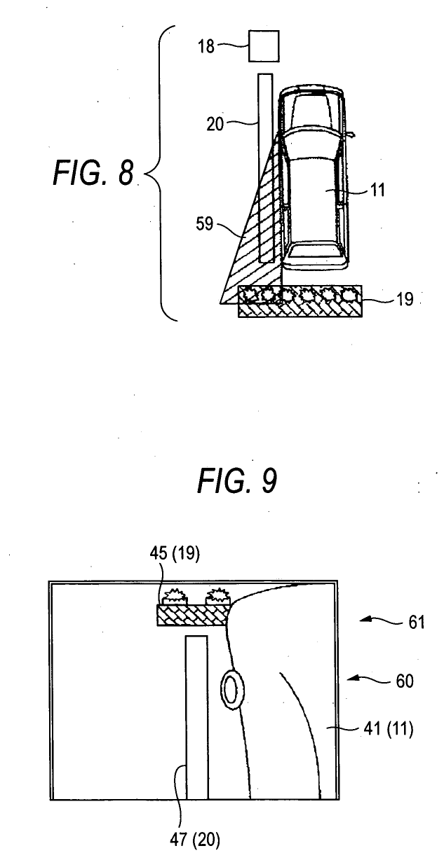

Thus, in this embodiment, the lower part 57 of the picked up image 50 shown in FIG. 5 (namely, an image in the range 59 of the visual field of the rear part of the vehicle 11 as shown in FIG. 8) is cut out and an image 60 is formed by vertically inverting the cut out image as shown in FIG. 9 (refer this image as to a “cut out and inverted image”, hereinafter).

The cut out and inverted image 60 corresponds to a mirror image (FIG. 7) in the rear part of the side part that the driver recognizes by using the mirror body 35 of the door mirror 21. Further, the cut out and inverted image 60 can be displayed on the display device as an image in the range of the visual field wider than that of the mirror body 35 of the door mirror 21. Accordingly, when the rear part of the side part is monitored, the rear part of the side part can be monitored with an amount of information larger than that of the door mirror 21 without an uneasy feeling. In this case, the cut out and inverted image 60 is desirably enlarged to meet the display resolution of the display device. In this case, the pixels of the image displayed on the display device may be possibly rough, however, when an ordinary interpolating process is employed, an image having no uneasiness can be displayed.

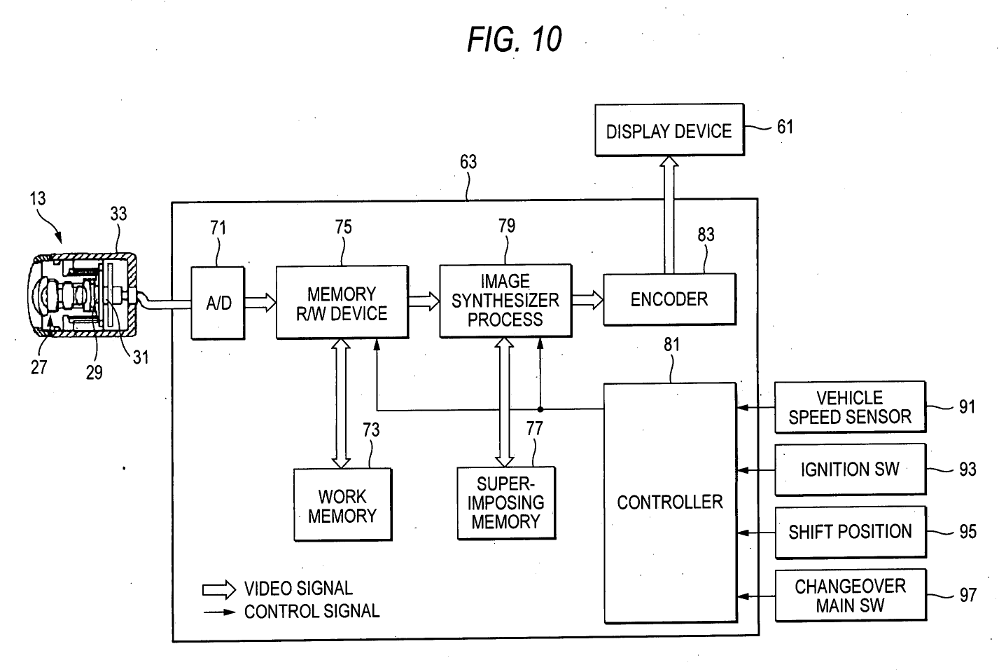

A example of the vehicle peripheral visual confirmation apparatus will be described. The apparatus includes, as shown in FIG. 10, the above-described camera 13, a display device 61 installed in, for instance, an instrument panel in an interior of the vehicle and a display controller 63 for processing the image of a video signal from the camera 13 and outputting the image to the display device 61.

The camera 13 is described above, so that an explanation thereof is omitted.

As the display device 61, a dot matrix type color liquid crystal display panel is employed that is provided as a monitor device of, for instance, a car navigation device.

The display controller 63 has a function for cutting out a part of the picked up image from the camera 13, a function for rotating the image and a function for inverting the image. As shown in FIG. 10, the display controller 63 includes an A/D converter 71 for sampling and quantizing an analog type video signal from the camera 13 and converting the vide signal to digital type video data, a work memory 73 for providing an area for temporarily storing the video data, a memory R/W device 75 for writing and reading the video data outputted from the A/D converter 71 relative to the work memory 73, cutting out the image and performing a coordinate transformation and an interpolating process, a superimposing memory 77 for providing a temporarily storing area for synthesizing an image, an image synthesizing process part 79 for synthesizing the image of the contents of data in the superimposing memory 77, a controller 81 for transmitting instruction signals (commands) respectively to the memory R/W device 75 and the image synthesizing process part 79 to control them and an encoder 83 for encoding the video data whose image is synthesized in the image synthesizing process part 79 to transmit a video signal to the display device 61.

Here, the controller 81 transmits the instruction signals respectively to the memory R/W device 75 and the image synthesizing process part 79 on the basis of signals from a vehicle speed sensor 91, an ignition switch (SW) 93, a shift position 95 and a changeover main switch (SW) 97. An operation of the controller 81 will be described below.

<Operation>

An operation of the vehicle peripheral visual confirmation apparatus will be described below.

For instance, while the ignition switch 93 is turned on, the controller 81 detects that the driver operates the changeover main switch 97 in accordance with the signal from the changeover main switch 97 to supply the instruction signal to the memory R/W device 75 and cut out the image and supply the instruction signal for synthesizing the image to the image synthesizing process part 79, and controls the memory R/W device 75 and the image synthesizing process part 79 to output the image 50 shown in FIG. 5 or the image 60 shown in FIG. 9 to the display device 61 while suitably switching the images 50 and 60.

Thus, for instance, when the vehicle 11 is put into a garage, not only the driver can recognize the rear part or the guide line (white line) 20 by inclining the mirror body 35 of the door mirror 21 as shown in FIG. 7 to put the vehicle into the garage, but also the driver can recognize a safety by the picked up image (reference numeral 50 in FIG. 5 or reference numeral 60 in FIG. 9) taken by the camera 30. Further, when the driver parks the vehicle in the forward direction, the driver can recognize a space from an adjacent vehicle.

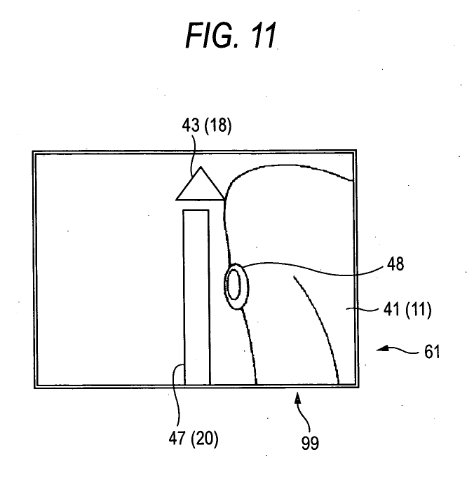

Further, not only the image 50 shown in FIG. 5 or the image 60 shown in FIG. 9, but also an image 99 including a part near a front wheel 48 in the forward part of the vehicle 11 may be superimposed and the obtained image may be displayed on the display device 61 as shown in FIG. 11 in accordance with the switching operation of the changeover main switch 97

Further, while the ignition switch 93 is turned on, the controller 81 automatically switches the image 50 shown in FIG. 5, the image 60 shown in FIG. 9 (the cut-out and inverted image) and the image 99 shown in FIG. 11 not only in accordance with the switching operation of the changeover main switch 97, but also in accordance with a vehicle signal from the shift position 95 or the vehicle speed sensor 91.

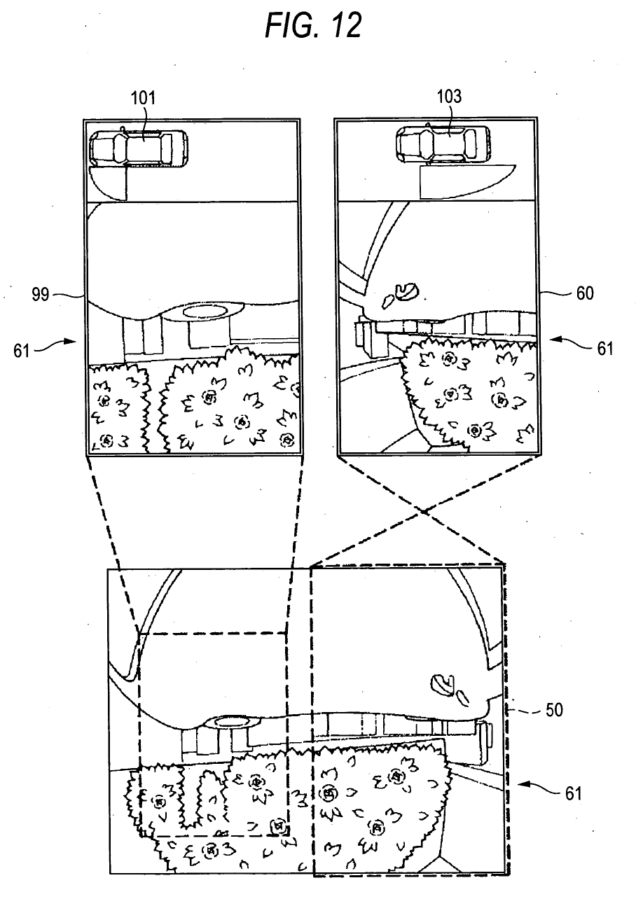

As shown in FIG. 12, while the ignition switch 93 is turned on, when the shift position 95 is in a state of R (back), the cut out and inverted image 60 of the rear part is displayed on the basis of the instruction signal from the controller 81. When the shift position 95 is in a state of D (move forward) and the vehicle speed of the vehicle speed sensor 91 is not higher than a prescribed value (for instance, 5 km/h), the image 99 at a dead angle in a left front part is displayed. Further, when the shift position 95 is in a state of P (parking) or N (neutral), an original image 50 is displayed. At this time, as shown by reference numeral 101 or 103 in FIG. 12, which direction of the image relative to the vehicle 11 is picked up is desirably displayed at a part of the display device 61.

The controller 81 may be independent from the shift position 95. For example, the controller 81 may be configured such that a driver can switch the images with operation by hand. The controller 81 may switch the images automatically.

In such a way, the image that driver can easily visually recognize can be displayed on the display device 61 depending on various kinds of states so that a convenience is improved.

Especially, for the image obtained by picking up the rear part, since the above-described cut out and inverted image 60 can be displayed on the display device 61, the image that the driver easily sensitively recognizes can be displayed.

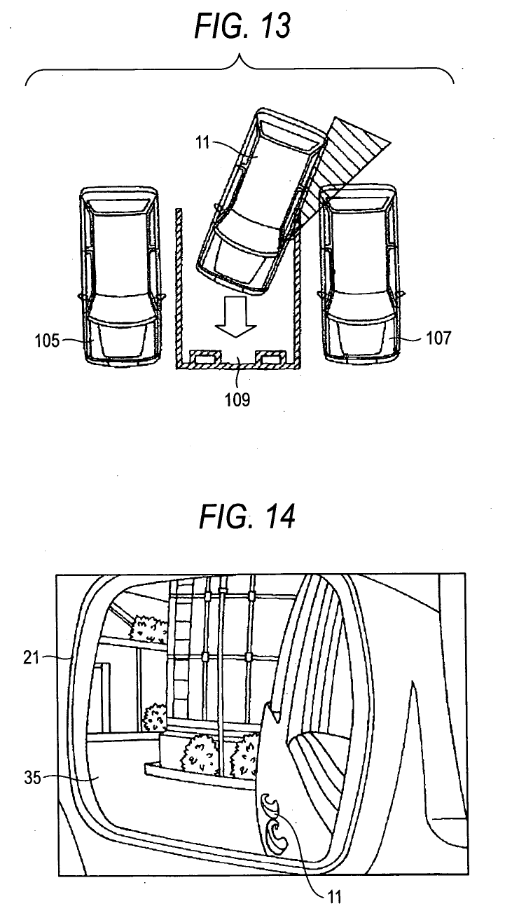

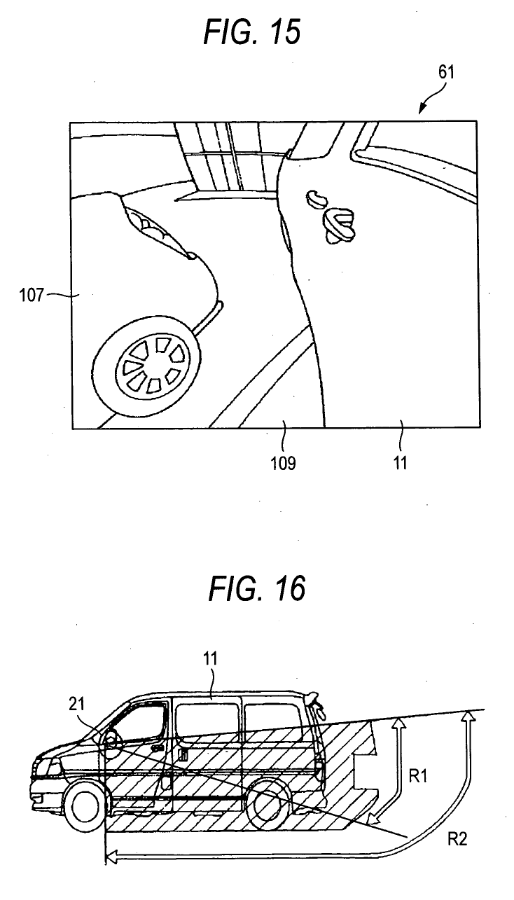

As shown in FIG. 13, when the vehicle 11 is moved forward to be put into a garage area 109 in which other vehicles 105 and 107 are respectively parked in both sides, a mirror image as shown in FIG. 14 is reflected on the mirror body 35 of the door mirror 21. As compared therewith, the cut out and inverted image 60 as shown in FIG. 15 is displayed on the display device 61. As shown in FIG. 16, the cut out and inverted image 60 having the range R2 of the visual field wider than the range R1 of the visual field of the mirror body 35 of the door mirror 21 can be displayed on the display device 61.

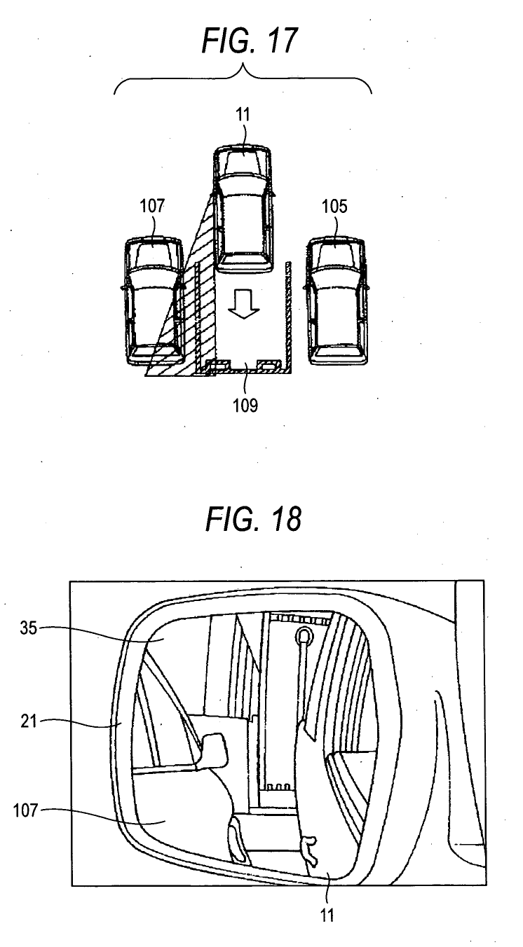

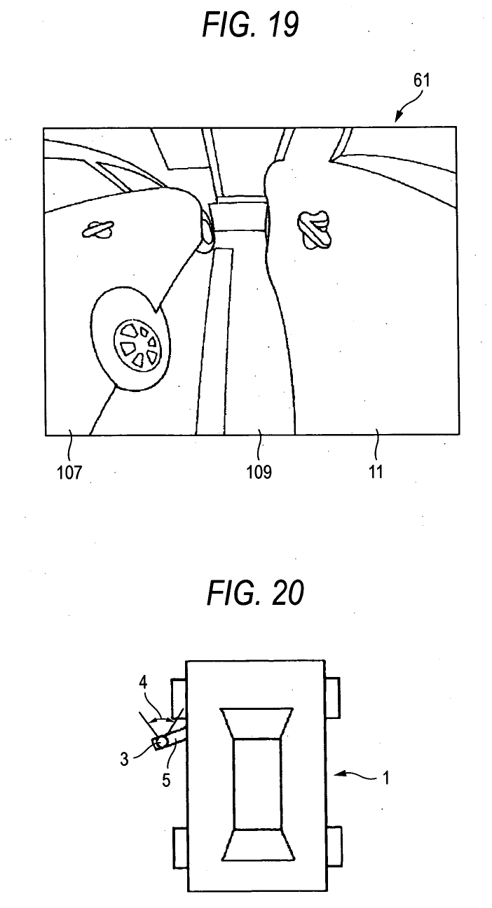

As shown in FIG. 17, when the vehicle 11 is moved backward to be put into the garage area 109 in which other vehicles 105 and 107 are respectively parked in both sides, a mirror image as shown in FIG. 18 is reflected on the mirror body 35 of the door mirror 21. As compared therewith, the cut out and inverted image 60 as shown in FIG. 19 is displayed on the display device 61. As shown in FIG. 16, the cut out and inverted image 60 having the range R2 of the visual field wider than the range R1 of the visual field of the mirror body 35 of the door mirror 21 can be displayed on the display device 61.

Accordingly, the driver can conveniently visually recognize the image that is easily sensitively recognized and has the wide range of the visual field including the dead angle.

Various kinds of the images 50, 60 and 99 shown in FIGS. 5, 9 and 11 are picked up by the single camera 13 having the lens system 27 that can pick up the image in the wide range of the visual field. The picked up image can be formed by image processes including a cutting out process, an enlarging process, a rotating process and an inverting process. Thus, various images that meet various types of conditions of a user can be easily provided only by using the camera 13 having the small number of parts.

What is claimed is:

1. A vehicle peripheral visual confirmation apparatus comprising:
a camera being disposed in a side part of vehicle, and the camera being simultaneously capable of picking up at least one of an image in a front part of the side part of vehicle and an image in a rear part of the side part of vehicle,
a display device displaying an image; and
a display controller processing the image picked up by the camera to output the processed image to the display device, the display controller operable to cut out a part of the image picked up by the camera, the display controller operable to rotate the image, and the display controller operable to invert the image.

2. A vehicle peripheral visual confirmation apparatus according to claim 1, wherein the display controller cuts out the image in the rear part of the vehicle among the images picked up by the camera, and
wherein the display controller performs at least one of a rotation of the cut-out image in a direction corresponding to the mirror image of door mirror and a inversion of the cut-out image in a direction corresponding to the mirror image of door mirror.

3. A vehicle peripheral visual confirmation apparatus according to claim 1, wherein the camera has a fisheye lens so that the two images can be picked up at the same time.

4. A vehicle peripheral visual confirmation apparatus according to claim 1, wherein the camera is disposed in the door mirror.

5. A vehicle peripheral visual confirmation apparatus according to claim 1, wherein when the display controller cuts out a part of the image picked up by the camera, the display controller synthesizes an image representing a range of a visual field of the cut-out image and controls the display device to display the synthesized image.
